(19) United States
(12) Patent Application Publication
(10) Pub. No.: US 2026/0201174 A1
(43) Pub. Date: Jul. 16, 2026

(54) METHOD OF PREPARING SUPER WEATHER-RESISTANT HAA-CURED MATTE POLYESTER RESIN AND APPLICATION THEREOF

(71) Applicant: ANHUI YOCHON NEW MATERIALS TECHNOLOGY CO.,LTD, HEFEI (CN)

(72) Inventors: LIANG XUE, HEFEI (CN); YOURONG YANG, HEFEI (CN); DAILIANG YU, HEFEI (CN); WEI GUO, HEFEI (CN); BAOYU LU, HEFEI (CN); HAIYANG SHEN, HEFEI (CN); QIYAN XIE, HEFEI (CN); YOUYU YANG, HEFEI (CN); HUANGSHAN GE, HEFEI (CN); SENLIN JIANG, HEFEI (CN)

(21) Appl. No.: 19/304,563

(22) Filed: Aug. 19, 2025

(30) Foreign Application Priority Data
Jan. 14, 2025 (CN) 202510053262.2

(51) Int. Cl. C09D 5/03; C08G 63/685; C08G 63/85; C08K 3/04; C08K 3/30; C08K 5/06; C08K 5/13; C08K 5/524; C09D 7/42; C09D 7/47; C09D 7/61; C09D 7/63; C09D 167/02

(52) U.S. Cl. CPC C09D 5/038; C08G 63/6856; C08G 63/85; C09D 7/42; C09D 7/47; C09D 7/61; C09D 7/63; C09D 167/02; C08K 3/04; C08K 2003/3045; C08K 5/06; C08K 5/13; C08K 5/524

(57) ABSTRACT

A triazine phenylimide diol monomer is prepared. The triazine phenylimide diol monomer, neopentyl glycol, and terephthalic acid undergo a co-esterification polymerization reaction, so as to obtain a super weather-resistant HAA-cured matte polyester resin. The super weather-resistant HAA-cured matte polyester resin is compounding with an HAA hydroxyalkyl amide curing agent, a matting agent benzoin, and a filler, so as to obtain a polyester resin powder coating. The polyester resin contains the triazine phenylimide diol monomer, which has a phenylimide ring and a triazine ring structure. Furthermore, a double-alkyl side chain is contained, and after the double-alkyl side chain is introduced into a molecular chain of the polyester, site blocking and shielding are provided to prevent water molecules from contacting polyester bonds in the molecular chain of the polyester.

### CROSS REFERENCE TO RELATED APPLICATIONS

The present application claims the priority of the Chinese patent application No. 202510053262.2, filed on Jan. 14, 2015, contents of which are incorporated herein by its entireties.

### TECHNICAL FIELD

Embodiments of the present disclosure relate to the technical field of polyester resins, and more specifically, to a method of preparing a super weather-resistant HAA-cured matte polyester resin and an application of the super weathering HAA-cured matte polyester resin.

### BACKGROUND

Polyester resin is produced by esterification and polycondensation of polyalcohol and polyacid. The polyester resin has ideal heat resistance, mechanical strength and corrosion resistance. The polyester resin may be made into powder coating, solvent coating and adhesive and may be widely used in building materials, outdoor furniture and equipment, transportation facilities, and so on. Improving water resistance, heat resistance and weather resistance of the polyester resin and the powder coating has thereof may have important applications. A polyester resin for powder coatings and a preparation method and application thereof are disclosed in the Chinese patent No. CN115626978B, in which the polyester resin is modified to have a bismaleimide group and an acrylate group, taking diamine, maleic anhydride, acrylate monomers, polyalcohols, polyacids and acidolytic agents as raw materials. The resulting powder coatings have ideal storage stability, ideal weather-resistant performance and heat-resistant performance. The powder coating has good storage stability, weather resistance and heat resistance. However, the polyester resin powder coating does not have ideal hydrolysis resistance and impact resistance.

### SUMMARY

The present disclosure provides a polyester resin having ideal weather resistance, water resistance, and heat resistance.

In an aspect, the present disclosure provides a method of preparing a super weather-resistant HAA-cured matte polyester resin, the method includes: sequentially adding polyol, dibasic acid and an esterification catalyst to a reaction container, so as to obtain a first solution; inputting a nitrogen gas into the reaction container; stirring the first solution, and at the same time, increasing a temperature of the reaction container; leaving the reaction container at 165-185° C. for reaction for 1-2 h; increasing the temperature of the reaction container to 240-250° C.; leaving the reaction container at 240-250° C. for reaction for 12-16 h, discharging water generated from an esterification reaction. When an acid value of the first solution reaches 5-20 mg KOH/g, adding an acidolytic agent to the first solution to obtain a second solution, leaving the second solution to undergo a reaction for 3-4 h. When an acid value of the second solution reaches 50-70 mg KOH/g, vacuumizing the reaction container, enabling the second solution to undergo a polycondensation reaction for 2-3 h. When the acid value of the second solution after undergoing the polycondensation reaction reaches 40-50 mg KOH/g, adding an onium salt curing accelerator and an antioxidant to the second solution to obtain a mixed second solution, stirring the mixed second solution for 20-40 min. The super weather-resistant HAA-cured matte polyester resin is obtained after the mixed second solution is discharged out of the reaction container and is cooled and crushed.

In some embodiments, the polyol is combination of neopentyl glycol and a triazine phenylimide diol monomer. A formula of the triazine phenylimide diol monomer is as follows:

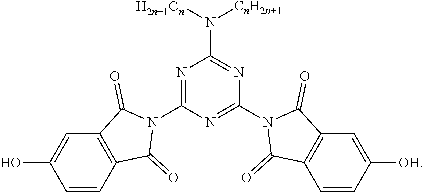

In some embodiments, 34-42 weight parts of the polyol, 48-50 weight parts of the dibasic acid, 20-28 weight parts of the acidolytic agent, 0.5-0.6 weight parts of the esterification catalyst, 0.4-0.5 weight parts of the antioxidant, and 0.1-0.13 weight parts of the onium salt curing promoter are used.

In some embodiments, the dibasic acid is terephthalic acid; the acidolytic agent comprises any one or a combination of: isophthalic acid, 1,4-cyclohexanedicarboxylic acid, and trimethylolpropane.

In some embodiments, the antioxidant is any one or a combination of: blocked phenolic antioxidant and phosphite ester antioxidant; the esterification catalyst is monobutyltin oxide; and the onium salt curing promoter is triphenyl ethyl phosphonium bromide.

In some embodiments, the triazine phenylimide diol monomer is prepared by:
(1) Adding N,N-dimethylformamide, 2-chloro-4,6-diamino-1,3,5-triazine, dialkylamine, potassium carbonate to another reaction container arranged with another condensation reflux tube, so as to obtain a third solution; inputting nitrogen gas to the another reaction container; increasing a temperature of the another reaction container to 130-140° C.; stirring the third solution for reaction for 24-30 h; pouring the third solution into water; pumping and filtering the third solution with the water to obtain a filter block and a filtered solution, the filtered solution serving as a first product; recrystallizing the first product to obtain 2-(alkylamine)-4,6-diamino-1,3,5-triazine. 2-(alkylamine)-4,6-diamino-1,3,5-triazine.

A formular of the dialkylamine is as follows:

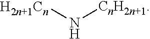

The n is any integer of 4 to 8.

A reaction equation of the (1) is as follows:

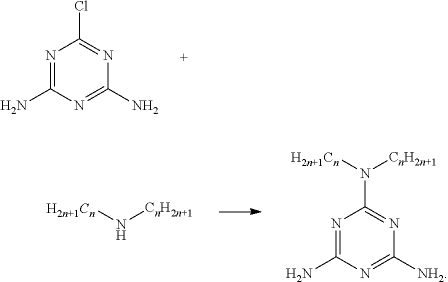

(2) Adding N-methylpyrrolidone, 2-(alkylamine)-4,6-diamino-1,3,5-triazine, 4-hydroxyphthalic anhydride to a second reaction container arranged with a second condensation reflux tube, so as to obtain a fourth solution; increasing a temperature of the second reaction container to 180-195° C.; stirring the fourth solution for reaction for 8-12 h; pouring the fourth solution into water; pump the filtering the fourth solution with the water to obtain a second filtered solution serving as a second product; and recrystallizing the second product to obtain the triazine phenylimide diol monomer.

A reaction equation of the (2) is as follows:

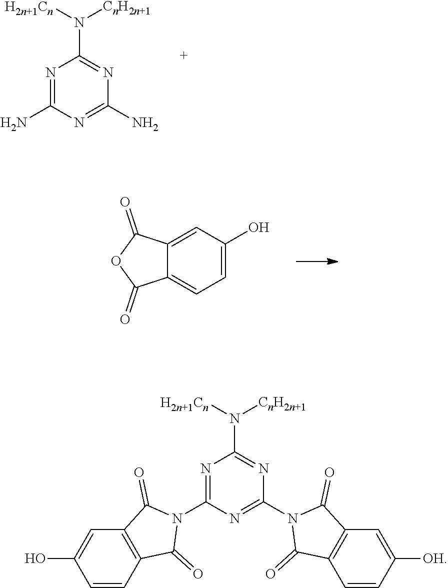

In some embodiments, in the (1), 100 weight parts of the 2-chloro-4,6-diamino-1,3,5-triazine, 89-128 weight parts of the dialkylamine, 95-104 weight parts of the potassium carbonate are used.

In some embodiments, in the (2), 100 weight parts of the 2-(alkylamine)-4,6-diamino-1,3,5-triazine and 112-156 weight parts of the 4-hydroxyphthalic anhydride are used.

In a second aspect, the present disclosure provides a power coating including the super weather-resistant HAA-cured matte polyester resin obtained by the method in the above. The power coating includes 62-68 weight parts of the super weather-resistant HAA-cured matte polyester resin, 5.2-6 weight parts of HAA hydroxyalkylamide curing agent, 0.9-1.2 weight parts of a leveling agent, 2.6-3.5 weight parts of a matting agent, 26-32 weight parts of a filler.

In some embodiments, the matting agent is benzoin, and the filler comprises any one or a combination of: carbon black and barium sulfate.

According to the present disclosure, a triazine phenylimide diol monomer is prepared, and the triazine phenylimide diol monomer, neopentyl glycol, terephthalic acid and so on undergo a co-esterification polymerization reaction, so as to obtain the super weather-resistant HAA-cured matte polyester resin. The super weather-resistant HAA-cured matte polyester resin is compounding with an HAA hydroxyalkyl amide curing agent, a matting agent benzoin, a filler and so on, so as to obtain a polyester resin powder coating. The polyester resin contains the triazine phenylimide diol monomer, which has a phenylimide ring and a triazine ring structure, providing heat resistance and structural stability. In this way, a resulting film may have high-temperature resistance and mechanical strength, exhibiting higher impact resistance. Furthermore, a double-alkyl side chain is contained, and after the double-alkyl side chain is introduced into a molecular chain of the polyester, a blocking and shielding effect is provided, preventing water molecules from contacting polyester bonds in the molecular chain of the polyester, such that hydrolysis of ester groups is reduced, and therefore, hydrolysis resistance of the polyester resin may be improved. After high temperature boiling, a paint film of the polyester resin may not be blistering and cracking, and anti-ultraviolet aging performance of the paint film may be improved, and the paint film may have better weather resistance and a high light retention rate.

### DETAILED DESCRIPTIONS

Technical solutions in the embodiments of the present disclosure will be described clearly and completely in the following by referring to the embodiments of the present disclosure. Apparently, the described embodiments are only a part of, not all of, the embodiments of the present disclosure. All other embodiments, which are obtained by any ordinary skilled person in the art based on the embodiments of the present disclosure without creative work, shall fall within the scope of the present disclosure

### Embodiment 1

(1) 200 mL of N,N-dimethylformamide, 2 g of 2-chloro-4,6-diamino-1,3,5-triazine, 2.28 g of di-n-hexylamine, 2.08 g of potassium carbonate are added to a reaction container arranged with a condensation reflux tube, and then nitrogen gas is input. A temperature of the reaction container is increased to 130° C., and stirring is performed for 24 h for reaction. A solution after the reaction is poured into water. The water with the solution is pumped and filtered to obtain a filter block. Petroleum ether is used to wash the filter block. In this way, a filtered solution, serving as a first product, is obtained. The first product is recrystallized with a mixed solution of petroleum ether and tetrahydrofuran, so as to obtain 2-(alkylamine)-4,6-diamino-1,3,5-triazine.
(2) 30 mL of N-methylpyrrolidone, 4 g of 2-(alkylamino)-4, 6-diamino-1,3,5-triazine, 5.28 g of 4-hydroxyphthalic anhydride are added to a reaction container arranged with a condensation reflux tube. A temperature of the reaction container is increased to 195° C., and stirring is performed for 8 h for reaction. A solution after the reaction is poured into water. The solution with the water is pumped and filtered to obtain a second filtered solution, serving as a first product. The second product is recrystallized with ethanol, so as to obtain a triazine phenylimide diol monomer.
(3) 30 g of neopentyl glycol, 4 g of triazine phenylimide diol monomer, 48 g of p-benzene dicarboxylic acid and 0.5 g of monobutyltin oxide as an esterification catalyst are sequentially added to a reaction container, and then nitrogen gas is input. Stirring and heating are performed at the same time. The reaction container is left at 170° C. for reaction for 2 h. Subsequently, a temperature of the reaction container is increased to reach to 240° C. The reaction container is left at 240° C. for reaction for 16 h, so as to discharge water generated by the esterification reaction. When an acid value reaches 20 mg of KOH/g, an acidolytic agent prepared from 21 g isophthalic acid, 5 g of 1,4-cyclohexanedicarboxylic acid, 2 g of a trimethylolpropane is added to the reaction container to have a reaction for 4 h. When the acid value reaches 60 mg KOH/g, the reaction container is vacuumized to enable substances in the reaction container to undergo a polycondensation reaction for 2 h. When the acid value reaches 50 mg KOH/g, 0.12 g of triphenyl ethyl phosphonium bromide serving as an onium salt curing promoter, 0.35 g of blocked phenol antioxidant 1076, and 0.15 g of phosphite ester antioxidant 168 are added, and then stirring is performed for 20 min. Furthermore, substances are discharged out of the reaction container and are cooled and crushed, so as to obtain the super weather-resistant HAA-cured matte polyester resin.

### Embodiment 2

(1) 200 mL of N,N-dimethylformamide, 2 g of 2-chloro-4,6-diamino-1,3,5-triazine, 2.23 g of di-n-hexylamine, 1.9 g of potassium carbonate are added to a reaction container arranged with a condensation reflux tube, and then nitrogen gas is input. A temperature of the reaction container is increased to 140° C., and stirring is performed for 24 h for reaction. A solution after the reaction is poured into water. The water with the solution is pumped and filtered to obtain a filter block. Petroleum ether is used to wash the filter block. In this way, a filtered solution, serving as a first product, is obtained. The first product is recrystallized with a mixed solution of petroleum ether and tetrahydrofuran, so as to obtain 2-(alkylamine)-4,6-diamino-1,3,5-triazine.
(2) 40 mL of N-methylpyrrolidone, 4 g of 2-(alkylamino)-4, 6-diamino-1,3,5-triazine, 4.48 g of 4-hydroxyphthalic anhydride are added to a reaction container arranged with a condensation reflux tube. A temperature of the reaction container is increased to 180° C., and stirring is performed for 12 h for reaction. A solution after the reaction is poured into water. The solution with the water is pumped and filtered to obtain a second filtered solution, serving as a first product. The second product is recrystallized with ethanol, so as to obtain a triazine phenylimide diol monomer.
(3) 30 g of neopentyl glycol, 8 g of triazine phenylimide diol monomer, 49.2 g of p-benzene dicarboxylic acid and 0.6 g of monobutyltin oxide as an esterification catalyst are sequentially added to a reaction container, and then nitrogen gas is input. Stirring and heating are performed at the same time. The reaction container is left at 185° C. for reaction for 1 h. Subsequently, a temperature of the reaction container is increased to reach to 250° C. The reaction container is left at 250° C. for reaction for 12 h, so as to discharge water generated by the esterification reaction. When an acid value reaches 5 mg of KOH/g, an acidolytic agent prepared from 15 g isophthalic acid, 4 g of 1,4-cyclohexanedicarboxylic acid, 1 g of a trimethylolpropane is added to the reaction container to have a reaction for 4 h. When the acid value reaches 70 mg KOH/g, the reaction container is vacuumized to enable substances in the reaction container to undergo a polycondensation reaction for 3 h. When the acid value reaches 50 mg KOH/g, 0.13 g of triphenyl ethyl phosphonium bromide serving as an onium salt curing promoter, 0.28 g of blocked phenol antioxidant 1076, and 0.12 g of phosphite ester antioxidant 168 are added, and then stirring is performed for 20 min. Furthermore, substances are discharged out of the reaction container and are cooled and crushed, so as to obtain the super weather-resistant HAA-cured matte polyester resin.

### Embodiment 3

(1) 150 mL of N,N-dimethylformamide, 2 g of 2-chloro-4,6-diamino-1,3,5-triazine, 1.78 g of di-n-hexylamine, 1.9 g of potassium carbonate are added to a reaction container arranged with a condensation reflux tube, and then nitrogen gas is input. A temperature of the reaction container is increased to 140° C., and stirring is performed for 24 h for reaction. A solution after the reaction is poured into water. The water with the solution is pumped and filtered to obtain a filter block. Petroleum ether is used to wash the filter block. In this way, a filtered solution, serving as a first product, is obtained. The first product is recrystallized with a mixed solution of petroleum ether and tetrahydrofuran, so as to obtain 2-(alkylamine)-4,6-diamino-1,3,5-triazine.
(2) 30 mL of N-methylpyrrolidone, 4 g of 2-(alkylamino)-4, 6-diamino-1,3,5-triazine, 6.24 g of 4-hydroxyphthalic anhydride are added to a reaction container arranged with a condensation reflux tube. A temperature of the reaction container is increased to 180° C., and stirring is performed for 12 h for reaction. A solution after the reaction is poured into water. The water with the solution is pumped and filtered to obtain a second filtered solution, serving as a second product. The second product is recrystallized with ethanol, so as to obtain a triazine phenylimide diol monomer.
(3) 30 g of neopentyl glycol, 12 g of triazine phenylimide diol monomer, 50 g of p-benzene dicarboxylic acid and 0.6 g of monobutyltin oxide as an esterification catalyst are sequentially added to a reaction container, and then nitrogen gas is input. Stirring and heating are performed at the same time. The reaction container is left at 165° C. for reaction for 2 h. Subsequently, a temperature of the reaction container is increased to reach to 250° C. The reaction container is left at 250° C. for reaction for 12 h, so as to discharge water generated by the esterification reaction. When an acid value reaches 20 mg of KOH/g, an acidolytic agent prepared from 18 g isophthalic acid, 4 g of 1,4-cyclohexanedicarboxylic acid, 1.6 g of a trimethylolpropane is added to the reaction container to have a reaction for 4 h. When the acid value reaches 50 mg KOH/g, the reaction container is vacuumized to enable substances in the reaction container to undergo a polycondensation reaction for 3 h. When the acid value reaches 40 mg KOH/g, 0.1 g of triphenyl ethyl phosphonium bromide serving as an onium salt curing promoter, 0.28 g of blocked phenol antioxidant 1076, and 0.12 g of phosphite ester antioxidant 168 are added, and then stirring is performed for 20 min. Furthermore, substances are discharged out of the reaction container and are cooled and crushed, so as to obtain the super weather-resistant HAA-cured matte polyester resin.

### Control Embodiment 1

(1) 34 g of neopentyl glycol, 48 g of terephthalic acid and 0.5 g of monobutyltin oxide as an esterification catalyst are sequentially added to a reaction container, and then nitrogen gas is input to the reaction container. Stirring and heating are performed at the same time. The reaction container is left at 170° C. for reaction for 2 h. Subsequently, the reaction container is heated to reach 240° C. and is left at 240° C. for reaction for 16 h, so as to discharge water generated from the esterification reaction. When an acid value reaches 20 mg KOH/g, an acidolytic agent prepared from 21 g of isophthalic acid, 5 g of 1,4 cyclohexanedicarboxylic acid, 2 g of trimethylolpropane is added to the reaction container for reaction for 4 h. When the acid value reaches 60 mg KOH/g, the reaction container is vacuumized for having the polycondensation reaction for 2 h. When the acid value reaches 50 mg KOH/g, 0.12 g of triphenyl ethyl phosphonium bromide serving as an onium salt curing promoter, 0.35 g of blocked phenol antioxidant 1076, and 0.15 g of phosphite ester antioxidant 168 are added, and then stirring is performed for 20 min. Furthermore, substances are discharged out of the reaction container and are cooled and crushed, so as to obtain a polyester resin.

### Control Embodiment 2

(1) 30 mL of N-methylpyrrolidone, 4 g of p-phenylenediamine, 5.28 g of 4-hydroxyphthalic anhydride are added to a reaction container arranged with a condensation reflux tube. A temperature of the reaction container is increased to 195° C. Stirring is performed for reaction for 8 h. A solution is poured into water, the water with the solution is pumped and filtered to obtain a filtered solution, serving as a first product. The first product is recrystallized with ethanol, so as to obtain a phenylimide diol monomer having a formula as follows:

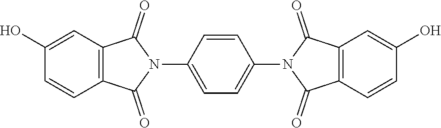 [SMILES: O=C1c2ccc(O)cc2C(=O)N1c1ccc(N2C(=O)c3ccc(O)cc3C2=O)cc1]

(2) 30 g of neopentyl glycol, 4 g of phenylimide diol monomer, 48 g of terephthalic acid and 0.5 g of monobutyltin oxide serving as the esterification catalyst are sequentially added to a reaction container, and then the nitrogen gas is input to the reaction container. Stirring and heating are performed at the same time. The reaction container is left at 170° C. for reaction for 2 h. Subsequently, a temperature of the reaction container is increased to 240° C., and the reaction container is left at 240° C. for reaction of 16 h, so as to discharge water generated from the esterification reaction. When an acid value reaches 20 mg KOH/g, an acidolytic agent prepared from 21 g of isophthalic acid, 5 g of 1,4 cyclohexanedicarboxylic acid, 2 g of trimethylolpropane is added to the reaction container for reaction for 4 h. When the acid value reaches 60 mg KOH/g, the reaction container is vacuumized to enable substances in the reaction container to undergo a condensation reaction for 2 h. When the acid value reaches 50 mg KOH/g, 0.12 g of triphenyl ethyl phosphonium bromide serving as an onium salt curing promoter, 0.35 g of blocked phenol antioxidant 1076, and 0.15 g of phosphite ester antioxidant 168 are added, and then stirring is performed for 20 min. Furthermore, substances are discharged out of the reaction container and are cooled and crushed, so as to obtain a super weather-resistant HAA-cured matte polyester resin.

### Control Embodiment 3

(1) 30 mL of N-methylpyrrolidone, 4 g of 4,6-dichloro-2-dimethylamino-1,3,5-homotriazine (CAS No. 2401-64-1), 5.28 g of 4-hydroxyphthalic anhydride are added to a reaction container arranged with a condensation reflux tube. A temperature of the reaction container is increased to 195° C., and stirring is performed for reaction for 8 h. A solution is poured into water. The water with the solution is pumped and filtered to obtain a filtered solution, serving as a first product, and the first product is recrystallized with ethanol to obtain a triazine phenylimide diol monomer.

A formula for the 4,6-dichloro-2-dimethylamino-1,3,5-homotriazine (CAS No. 2401-64-1) is as follows:

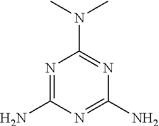

A formula of the triazine phenylimide diol monomer is as follows:

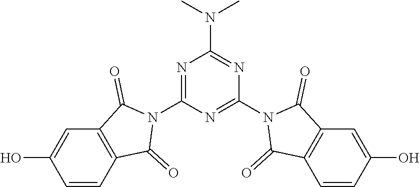 [SMILES: CN(C)c1nc(N2C(=O)c3ccc(O)cc3C2=O)nc(N2C(=O)c3ccc(O)cc3C2=O)n1]

(2) 30 g of neopentyl glycol, 4 g of phenylimide diol monomer, 48 g of terephthalic acid and 0.5 g of monobutyltin oxide serving as the esterification catalyst are sequentially added to a reaction container, and then the nitrogen gas is input to the reaction container. Stirring and heating are performed at the same time. The reaction container is left at 170° C. for reaction for 2 h. Subsequently, a temperature of the reaction container is increased to 240° C., and the reaction container is left at 240° C. for reaction of 16 h, so as to discharge water generated from the esterification reaction. When an acid value reaches 20 mg KOH/g, an acidolytic agent prepared from 21 g of isophthalic acid, 5 g of 1,4 cyclohexanedicarboxylic acid, 2 g of trimethylolpropane is added to the reaction container for reaction for 4 h. When the acid value reaches 60 mg KOH/g, the reaction container is vacuumized to enable substances in the reaction container to undergo a condensation reaction for 2 h. When the acid value reaches 50 mg KOH/g, 0.12 g of triphenyl ethyl phosphonium bromide serving as an onium salt curing promoter, 0.35 g of blocked phenol antioxidant 1076, and 0.15 g of phosphite ester antioxidant 168 are added, and then stirring is performed for 20 min. Furthermore, substances are discharged out of the reaction container and are cooled and crushed, so as to obtain a super weather-resistant HAA-cured matte polyester resin.

The acid value of the polyester resin in each above embodiment is tested according to the standard GB/T 6743-2008.

A viscometer is used to test viscosity of the polyester resin in each above embodiment, and a temperature of the viscometer is set to 200° C. After the temperature is stabilized, a sample of the polyester resin is taken and placed at a center of a test stage of the viscometer, and the viscosity is measured.

The polyester resin is tested by a differential scanning calorimetry (DSC). A 10 mg sample of the polyester resin in each above embodiment is weighed and placed on a carrier table of the DSC. Parameters are set up in a program of the DCS, and DSC measurement is performed. A temperature range of the measurement is 25-100° C., and the temperature is increased in a rate of 10° C./min. Results of tests are shown in Table 1.

TABLE 1
Polyester resin performance test

| | Acid value | Viscosity | glass transition |
|---|---|---|---|
| | (mg KOH/g) | (mPa · S) | temperature(° C.) |
| Embodiment 1 | 52.3 | 2617 | 70.8 |
| Embodiment 2 | 51.9 | 2850 | 75.0 |
| Embodiment 3 | 47.4 | 2892 | 77.9 |
| Control | 52.1 | 2521 | 62.8 |
| Embodiment 1 | | | |
| Control | 51.7 | 2949 | 69.2 |
| Embodiment 2 | | | |
| Control | 52.8 | 2865 | 71.3 |
| Embodiment 3 | | | |

According to the testing, the polyester resins prepared in the above embodiments all have moderate acid values and viscosity values. For the Embodiments 1 to 3 and the Control Embodiment 3, the polyester resins have higher glass transition temperatures. This is because the triazine phenylimide diol has an imide ring and a triazine ring providing heat stability, and the imide ring and the triazine ring are introduced into the molecular chain of the polyester. In this way, the glass transition temperature of the polyester resin is increased, and heat-resistant performance of the polyester resin is improved.

Embodiment 4: 650 g of the super weather-resistant HAA-cured matte polyester resin (prepared according to the method of Embodiment 1), 9 g of a leveling agent, 26 g of a matting agent benzoin, 310 g of barium sulphate, 10 g of carbon black, and 55 g of HAA hydroxyalkyl amide curing agent are stirred and mixed to obtain a powder coating.

Embodiment 5: 650 g of the super weather-resistant HAA-cured matte polyester resin (prepared according to the method of Embodiment 2), 12 g of a leveling agent, 35 g of a matting agent benzoin, 254 g of barium sulphate, 6 g of carbon black, and 60 g of HAA hydroxyalkyl amide curing agent are stirred and mixed to obtain a powder coating.

Embodiment 6: 620 g of the super weather-resistant HAA-cured matte polyester resin (prepared according to the method of Embodiment 3), 9 g of a leveling agent, 30 g of a matting agent benzoin, 275 g of barium sulphate, 6 g of carbon black, and 52 g of HAA hydroxyalkyl amide curing agent are stirred and mixed to obtain a powder coating.

Control embodiment 4: 650 g of the polyester resin (prepared according to the method of Control embodiment 1), 9 g of a leveling agent, 26 g of a matting agent benzoin, 310 g of barium sulphate, 10 g of carbon black, and 55 g of HAA hydroxyalkyl amide curing agent are stirred and mixed to obtain a powder coating.

Control embodiment 5: 650 g of the super weather-resistant HAA-cured matte polyester resin (prepared according to the method of Control embodiment 2), 9 g of a leveling agent, 26 g of a matting agent benzoin, 310 g of barium sulphate, 10 g of carbon black, and 55 g of HAA hydroxyalkyl amide curing agent are stirred and mixed to obtain a powder coating.

Control embodiment 6: 650 g of the super weather-resistant HAA-cured matte polyester resin (prepared according to the method of Control embodiment 3), 9 g of a leveling agent, 26 g of a matting agent benzoin, 310 g of barium sulphate, 10 g of carbon black, and 55 g of HAA hydroxyalkyl amide curing agent are stirred and mixed to obtain a powder coating.

The powder coating of each above embodiment is extruded, pressed and crushed by a twin-screw extruder, passed through a 200 mesh filter, and then sprayed on a substrate by electrostatic spraying, and the sprayed powder coating is cured at 180° C. for 15 min. Tests of immersion in boiling water are performed according to the standard of GB/T 1733-1993, where the substrate with the cured powder coating is boiled in boiling water for 96 h.

Impact resistance of the paint film is tested according to the standard of GB/T 1732-2020. The paint film has a thickness oft 70 um.

An adhesion grade is tested according to the standard GB/T 9286-2021.

60° mirror gloss of the paint film is tested according to the standard GB/T 9754-2007. The paint film is placed in a UV aging tester, a light source is a 340 nm UV lamp. Artificially accelerated aging is performed for 720 h, and 60° mirror gloss of the paint film is tested, and a light retention rate is calculated. Test results are shown in Table 2.

TABLE 2
Powder coating performance tests

| | | | | 60° | light |
|---|---|---|---|---|---|
| | Resistance to | Resistance | adhesion | mirror | retention |
| | boiling water | to impact | grade | gloss | rate |
| Embodiment | No bubble, | 50 | 0 | 11.8 | 85.5 |
| 4 | no crack, | | | | |
| | slightly color | | | | |
| | change | | | | |
| Embodiment | No bubble, | 60 | 0 | 7.6 | 90.7 |
| 5 | no crack, no | | | | |
| | color change | | | | |
| Embodiment | No bubble, | 50 | 0 | 7.2 | 88.4 |
| 6 | no crack, no | | | | |
| | color change | | | | |
| Control | Having | 30 | 0 | 10.5 | 80.9 |
| embodiment | bubbles and | | | | |
| 4 | cracks, | | | | |
| | having color | | | | |
| | change | | | | |
| Control | Having | 45 | 0 | 11.1 | 84.3 |
| embodiment | bubbles and | | | | |
| 5 | cracks, slight | | | | |
| | color change | | | | |
| Control | Having | 50 | 0 | 11.4 | 85.7 |
| embodiment | bubbles, no | | | | |
| 6 | crack, slight | | | | |
| | color change | | | | |

According to the above tests, compared to the Control embodiments 4-6, the powder coatings of the Embodiments 4-6 have better resistance to boiling water, excellent heat and hydrolysis resistance. With the artificially accelerated aging, paint films made from the powder coatings of the Embodiments 4-6 have higher light retention rates, stronger weather-resistant performance, and high impact resistance. This is because the polyester resins of the Embodiments 4-6 contain the triazine phenylimide diol monomer, which has heat resistance and structural stability due to the phenylimide ring and triazine ring, facilitating the paint film to have improved temperature resistance and mechanical strength. Furthermore, the polyester resins of the Embodiments 4-6 contain double-alkyl side chains, after the double-alkyl side chains are introduced into the molecular chain of the polyester, the double-alkyl side chains provide a site-blocking and shielding effect, inhibiting water molecules from contacting ester bonds in the molecular chain of the polyester, reducing hydrolysis of the ester group. In this way, resistance to hydrolysis of the polyester resin is improved. After high temperature boiling, the paint film made of the polyester resin has no bubbles or cracks. The anti-UV aging performance of the paint film is improved, and the weather resistance and the light retention rate thereof are improved.

What is claimed is:

1. A method of preparing a super weather-resistant HAA-cured matte polyester resin, the method comprising:
sequentially adding polyol, dibasic acid and an esterification catalyst to a reaction container, so as to obtain a first solution; inputting a nitrogen gas into the reaction container; stirring the first solution, and at the same time, increasing a temperature of the reaction container; leaving the reaction container at 165-185° C. for reaction for 1-2 h; increasing the temperature of the reaction container to 240-250° C.; leaving the reaction container at 240-250° C. for reaction for 12-16 h, discharging water generated from an esterification reaction;
when an acid value of the first solution reaches 5-20 mg KOH/g, adding an acidolytic agent to the first solution to obtain a second solution, leaving the second solution to undergo a reaction for 3-4 h;
when an acid value of the second solution reaches 50-70 mg KOH/g, vacuumizing the reaction container, enabling the second solution to undergo a polycondensation reaction for 2-3 h;
when the acid value of the second solution after undergoing the polycondensation reaction reaches 40-50 mg KOH/g, adding an onium salt curing accelerator and an antioxidant to the second solution to obtain a mixed second solution, stirring the mixed second solution for 20-40 min;
obtaining the super weather-resistant HAA-cured matte polyester resin after the mixed second solution being discharging out of the reaction container and being cooled and crushed;
wherein, the polyol is combination of neopentyl glycol and a triazine phenylimide diol monomer;
a formula of the triazine phenylimide diol monomer is as follows: 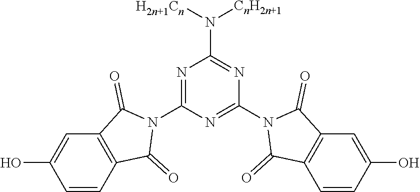
wherein the n is any integer of 4 to 8.

2. The method according to claim 1, wherein, 34-42 weight parts of the polyol, 48-50 weight parts of the dibasic acid, 20-28 weight parts of the acidolytic agent, 0.5-0.6 weight parts of the esterification catalyst, 0.4-0.5 weight parts of the antioxidant, and 0.1-0.13 weight parts of the onium salt curing promoter are used.

3. The method according to claim 2, wherein, the dibasic acid is terephthalic acid; the acidolytic agent comprises any one or a combination of: isophthalic acid, 1,4-cyclohexanedicarboxylic acid, and trimethylolpropane.

4. The method according to claim 2, wherein the antioxidant is any one or a combination of: blocked phenolic antioxidant and phosphite ester antioxidant; the esterification catalyst is monobutyltin oxide; and the onium salt curing promoter is triphenyl ethyl phosphonium bromide.

5. The method according to claim 1, wherein, the triazine phenylimide diol monomer is prepared by:
(1) adding N,N-dimethylformamide, 2-chloro-4,6-diamino-1,3,5-triazine, dialkylamine, potassium carbonate to another reaction container arranged with another condensation reflux tube, so as to obtain a third solution; inputting nitrogen gas to the another reaction container; increasing a temperature of the another reaction container to 130-140° C.; stirring the third solution for reaction for 24-30 h; pouring the third solution into water; pumping and filtering the third solution with the water to obtain a filter block and a first filtered solution, the first filtered solution serving as a first product; recrystallizing the first product to obtain 2-(alkylamine)-4,6-diamino-1,3,5-triazine. 2-(alkylamine)-4,6-diamino-1,3,5-triazine;
(2) adding N-methylpyrrolidone, 2-(alkylamine)-4,6-diamino-1,3,5-triazine, 4-hydroxyphthalic anhydride to a second reaction container arranged with a second condensation reflux tube, so as to obtain a fourth solution; increasing a temperature of the second reaction container to 180-195° C.; stirring the fourth solution for reaction for 8-12 h; pouring the fourth solution into water; pump and filtering the fourth solution with the water to obtain a second filtered solution serving as a second product; and recrystallizing the second product to obtain the triazine phenylimide diol monomer, wherein, a formular of the dialkylamine is as follows: 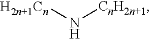
wherein the n is any integer of 4 to 8.

6. The method according to claim 5, wherein, in the (1), 100 weight parts of the 2-chloro-4,6-diamino-1,3,5-triazine, 89-128 weight parts of the dialkylamine, 95-104 weight parts of the potassium carbonate are used.

7. The method according to claim 5, wherein, in the (2), 100 weight parts of the 2-(alkylamine)-4,6-diamino-1,3,5-triazine and 112-156 weight parts of the 4-hydroxyphthalic anhydride are used.

8. A power coating comprising the super weather-resistant HAA-cured matte polyester resin obtained by the method according to claim 1, wherein, the power coating comprises 62-68 weight parts of the super weather-resistant HAA-cured matte polyester resin, 5.2-6 weight parts of HAA hydroxyalkylamide curing agent, 0.9-1.2 weight parts of a leveling agent, 2.6-3.5 weight parts of a matting agent, 26-32 weight parts of a filler.

9. The power coating according to claim 8, wherein the matting agent is benzoin, and the filler comprises any one or a combination of: carbon black and barium sulfate.
